(19) United States
(12) Patent Application Publication
(10) Pub. No.: US 2025/0206214 A1
(43) Pub. Date: Jun. 26, 2025

(54) TETHER STRUCTURE

(71) Applicant: NISSAN NORTH AMERICA, INC., Franklin, TN (US)

(72) Inventor: James HUNT, Fenton, MI (US)

(21) Appl. No.: 18/395,470

(22) Filed: Dec. 22, 2023

(51) Int. Cl. B60N 2/90; B60N 2/68; B60N 2/80

(52) U.S. Cl. CPC B60N 2/90; B60N 2/68; B60N 2/80; B60N 2002/899; B60N 2002/905

(57) ABSTRACT

A tether structure includes a seat assembly and a support bracket. The seat assembly has a frame structure and an outer cushion portion. The support bracket is installed to an upper end of the frame structure of the seat assembly. The support bracket includes a tether flange located rearward of the frame structure adjacent to a top surface of the outer cushion portion of the seat assembly.

### BACKGROUND

### Technical Field

The present disclosure generally relates to a tether structure for anchoring an infant's or small child's seat to a rear seat assembly of a motor vehicle. More specifically, the present disclosure relates to a tether structure located along an upper end of an upright portion of a rear seat structure that can be reached by a vehicle operator or vehicle passenger for attachment of an anchor strap of a small child's seat without moving the upright portion of the rear seat structure out of an upright orientation.

### Background Information

Motorized vehicles with a rear seat assembly usually have associated therewith tether attachment structures that are provided for securing a child's seat. The tether attachment structures can be fixedly attached to vehicle body structures rearward of the rear seat assembly or alternatively fixedly attached to a back side of the rear seat assembly. Such tether attachment structures require movement of an upright portion of the rear seat assembly away from an upright orientation toward a cargo receiving orientation in order for a parent or vehicle operator to attach a strap from the child's seat to one of the tether attachment structures.

### SUMMARY

One object of the present disclosure is to provide a tether attachment structure in a location such that a strap from the child's seat can be attached to one of the tether attachment structures without lowering an upright portion of the rear seat assembly.

In view of the state of the known technology, one aspect of the present disclosure is to provide a tether structure with a seat assembly and a support bracket. The seat assembly has a frame structure and an outer cushion portion. The support bracket is installed to an upper end of the frame structure of the seat assembly. The support bracket includes a tether flange located rearward of the frame structure adjacent to a top surface of the outer cushion portion of the seat assembly.

### BRIEF DESCRIPTION OF THE DRAWINGS

Referring now to the attached drawings which form a part of this original disclosure:

FIG. 1 is a perspective view of a passenger compartment of a motorized vehicle showing front seats and a rear seat assembly in accordance with various embodiments;

FIG. 2 is a perspective view of a forward side of the rear seat assembly removed from the motorized vehicle in accordance with the various embodiments;

FIG. 3 is a perspective view of a rearward side of the rear seat assembly removed from the motorized vehicle in accordance with the first embodiment;

FIG. 4 top view of the rear seat assembly in accordance with the first embodiment;

FIG. 5 is a perspective view of the rearward side of a portion of the rear seat assembly in accordance with the first embodiment;

FIG. 6 is a cross-sectional view of an upper portion of the portion of the rear seat assembly taken along the line 6-6 in FIG. 4 showing a frame structure and an outer cushion portion of the portion of the rear seat assembly in accordance with the first embodiment;

FIG. 7 is another perspective view of the rearward side of a portion of the rear seat assembly similar to FIG. 5 with the outer cushion portion removed showing the frame structure in accordance with the first embodiment;

FIG. 8 is a perspective view of a portion of the frame structure of the rear seat assembly shown in FIG. 7 showing the outboard upper corner of the frame structure in accordance with the first embodiment;

FIG. 9 is a cross-sectional top view of a portion of the frame structure of the rear seat assembly taken along the line 9-9 in FIG. 5, showing details of a support bracket attached to the frame structure in accordance with the first embodiment;

FIG. 10 is a rearward side view of the frame structure of the seat assembly in accordance with the first embodiment;

FIG. 11 is a rearward side view of the frame structure of the seat assembly in accordance with a second embodiment;

FIG. 12 is a rearward side view of the frame structure of the seat assembly in accordance with a third embodiment;

FIG. 13 is a rearward side view of the frame structure of the seat assembly in accordance with a fourth embodiment;

FIG. 14 is a rearward side view of the frame structure of the seat assembly in accordance with a fifth embodiment;

FIG. 15 is a rearward side view of the frame structure of the seat assembly in accordance with a sixth embodiment; and

FIG. 16 is a rearward side view of the frame structure of the seat assembly in accordance with a seventh embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

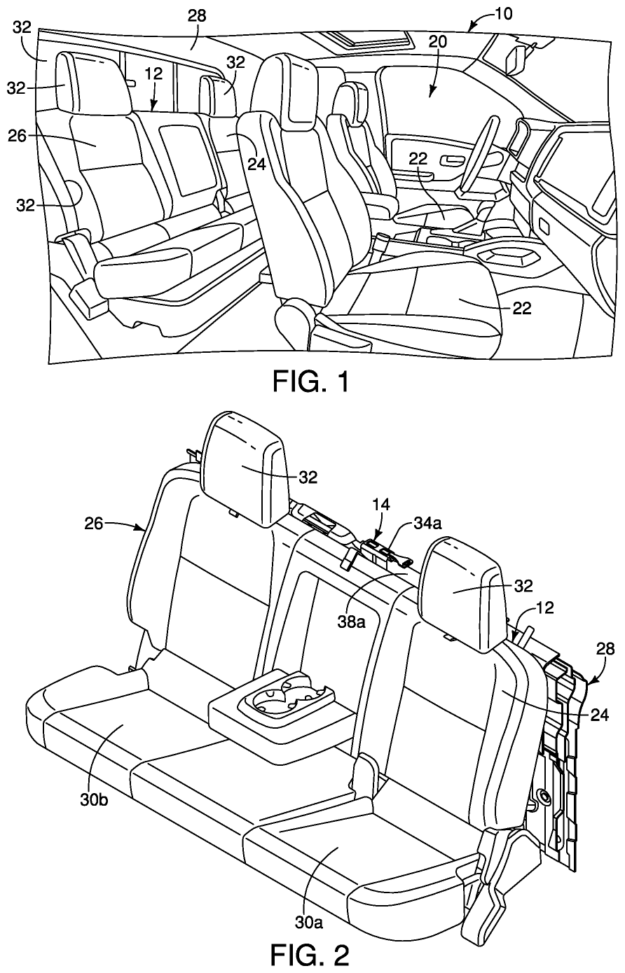

Referring initially to FIGS. 1 and 2, a vehicle 10 includes a rear seat assembly 12 that having a tether structure 14 (FIG. 2) is illustrated in accordance with a first embodiment. The tether structure 14 is attached to portions of the rear seat assembly 12 in a manner described in greater detail below.

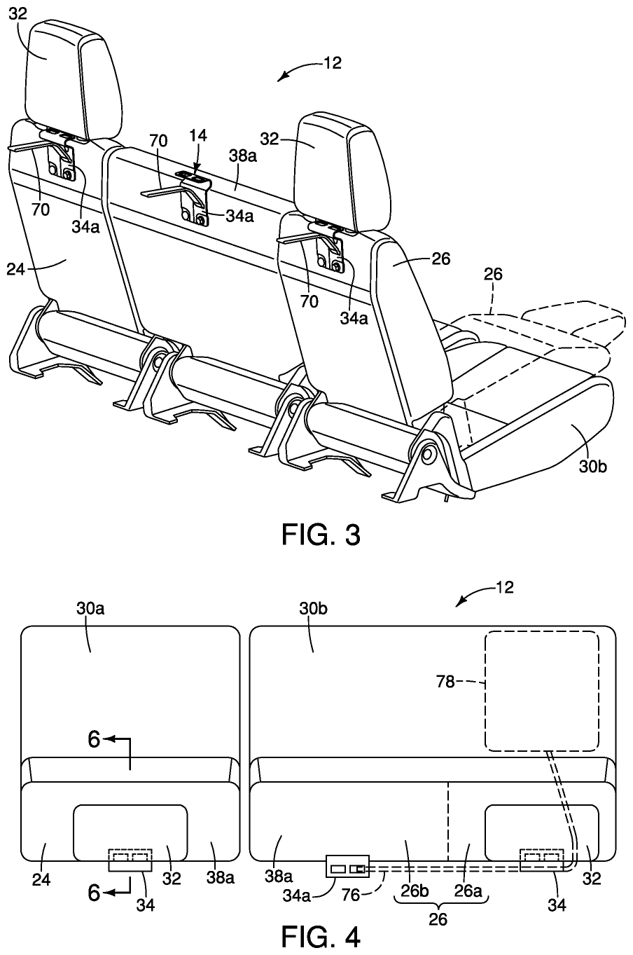

The vehicle 10 includes a vehicle body structure that defines a passenger compartment 20. The passenger compartment 20 is equipped with front seats 22 and the rear seat assembly 12 (hereinafter referred to as the seat assembly 12). The rear seat includes upright portions 24 and 26 that are dimensioned with an approximate 40% (upright portion 24) and 60% (upright portion 26) seat division. Both upright portions 24 and 26 can be moved from an upright orientation (see FIGS. 1-4) to a folded down orientation shown in phantom in FIG. 3.

In the depicted embodiments, the vehicle 10 is a pickup truck that has what is sometimes referred to as a crew cab, meaning that the passenger compartment 20 includes the front seats 22 and has sufficient space for the rear seat assembly 12 rearward of the front seats 22. The seat assembly 12 is installed within the passenger compartment 20 such that when the upright portions 24 and 26 of the seat assembly 12 are in their respective upright orientations, upper ends of the upright portions 24 and 26 are position immediately adjacent to a rear wall 28 (see FIG. 2) of the passenger compartment 20 with only a small gap of, for example one to three inches, between the upright portion 24 and the rear wall 28 of the passenger compartment 20.

In addition to the upright portions 24 and 26, the seat assembly 12 further includes seat portions 30a and 30b that can be fixed in an approximate horizontal orientation (with slight incline for comfort) or, alternatively can be pivoted upward exposing space beneath the seat portions 30. The seat assembly 12 also includes headrests 32. The upright portion 26 is wider than the upright portion 24, as shown in FIG. 4. Further, the upright portion 26 and the seat portion 30b have approximately the same width (as measured in a lengthwise direction of the seat assembly 12 and a lateral direction of the vehicle 10. More specifically, the upright portion 26 includes an outboard section 26a and a central portion 26b. The central portion 26b does not include a headrest in the depicted embodiment. The outboard section 26a does include one of the headrests 32. Since headrests are a conventional seat feature, further description is omitted for the sake of brevity.

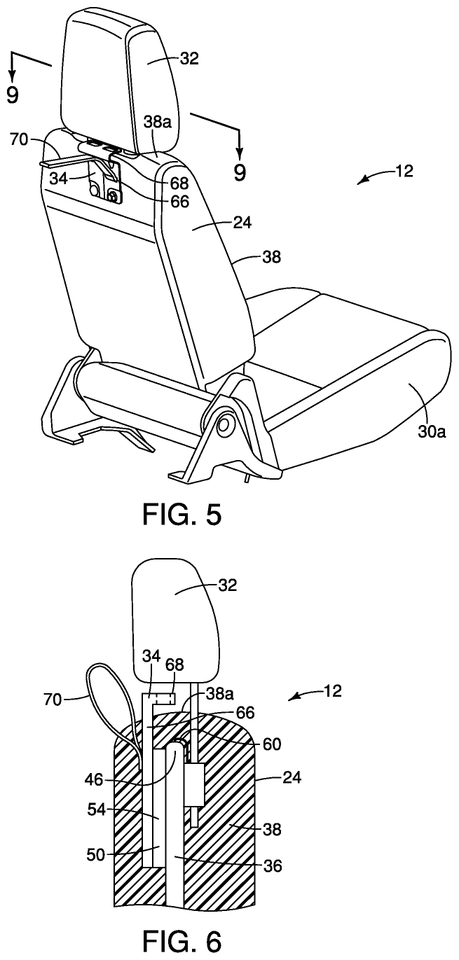

As shown in FIGS. 3-5, the tether structure 14 includes two tether brackets 34 and one tether bracket 34a that are all attached to a rearward side of the upright portions 24 and 26 of the seat assembly 12. More specifically, one of the tether brackets 34 is attached to the upright portion 24. The other of the tether brackets 34 is attached to the upright portion 26 at the outboard section 26a. The tether bracket 34a is attached to the upright portion 26 at the outboard section 26b, as described in greater detail below.

As shown in FIG. 6, the seat assembly 12 is constructed with a frame structure 36 and an outer cushion portion 38 that surrounds the frame structure 36 in a conventional manner. Since the outer cushion portion 38 is a conventional portion of vehicle seats, further description is omitted for the sake of brevity.

As shown in FIGS. 6-10, the frame structure 36 includes a first side section 42, a second side section 44 and an upper section 46 (also referred to as the top section 46). The first and second side sections 42 and 44 are generally upright beams or tubes that define the sides of the frame structure 36. The upper section 46 (the top section 46) at least partially defines the upper end of the frame structure 36. The upper section 46 extends from the first side section 42 to the second side section 44. In the depicted embodiment, the first side section 42, the second side section 44 and the upper section 46 are unitarily formed as a single element. For example, the first side section 42, the second side section 44 and the upper section 46 can be formed from a bent or molded tube-like metallic material or other material with sufficient strength to withstand all the forces expected to be applied to a seat frame structure. Alternatively, the first side section 42, the second side section 44 and the upper section 46 can be separate elements attached to one another by, for example, welding techniques to form the rigid frame structure 36.

The frame structure 36 further includes a support bracket 50 that is installed to at least the upper section 46 (the upper end) of the frame structure 36 in a manner described further below. The support bracket 50 further defines part of the tether structure 14, as described further below.

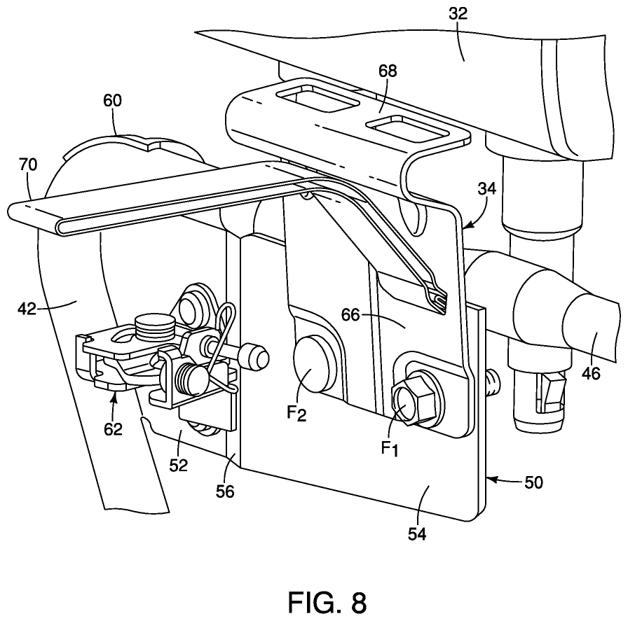

As shown in FIGS. 8, 9 and 10, the support bracket 50 includes a first portion 52, a second portion 54 and an offset portion 56. The first portion 52 includes and upper curved section 60 that curves part way up an area of the frame structure 36 at the curved intersection of the first side section 42 and the upper section 46. The curved section 60 is preferably welded to both the first side section 42 and the upper section 46.

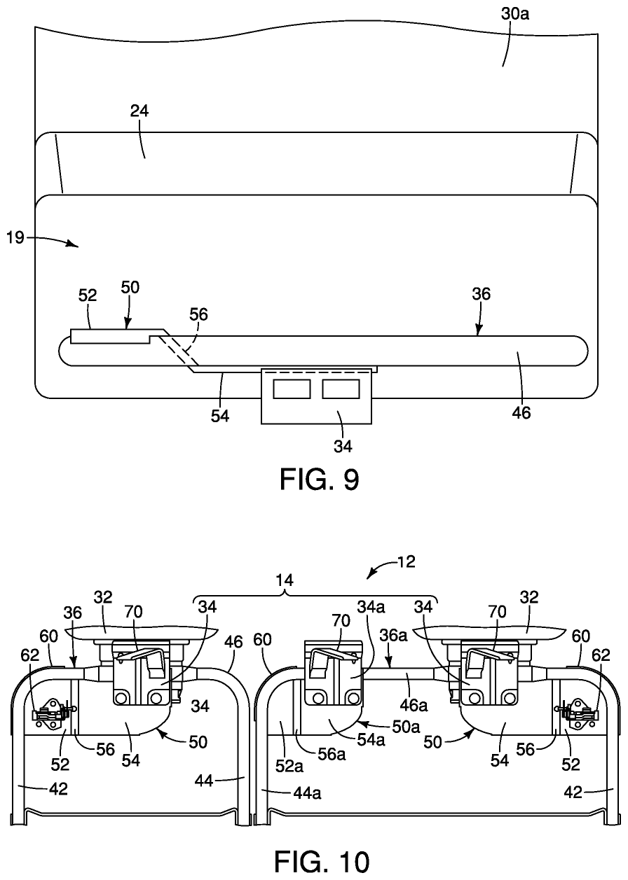

The offset portion 56 is defined by a pair of parallel bent areas of the support bracket 50, as shown in FIG. 9. The offset portion 56 is located beneath the upper section 46 of the frame structure 36 such that the second portion 54 can extend upward along a rearward side of the upper section 46. The upper end of the second portion 54 of the support bracket 50 is welded to the rearward side of the upper section 46 of the frame structure, as shown in FIG. 8.

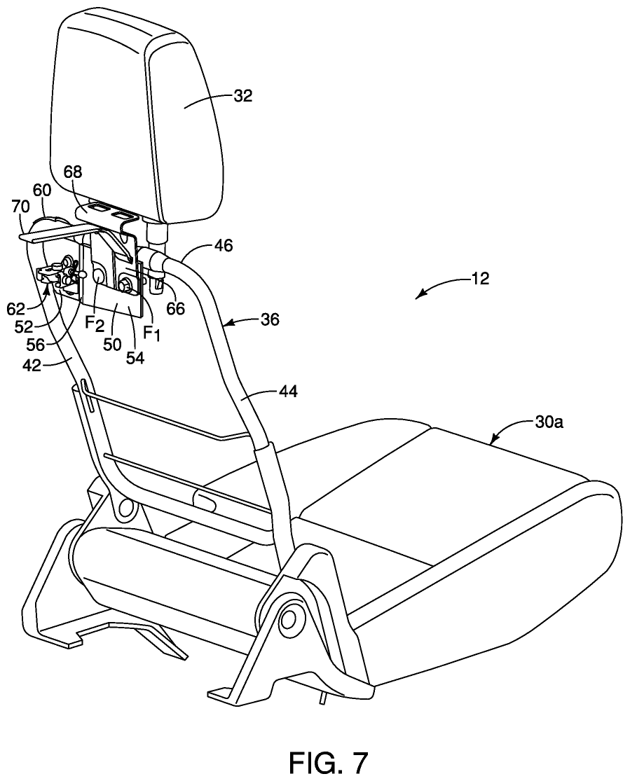

As shown in FIGS. 7-10, a latch mechanism 62 is attached to the rearward surface of the support bracket 50 outboard of the tether bracket 34. The latch mechanism 62 is configured to retain the upright portion 24 in its upright orientation. Operation of the latch mechanism 62 frees the upright portion 24 of the seat assembly 12 from the rear wall 28 such that the upright portion 24 can move to the folded down orientation. Since such latch mechanisms 62 and their releasable engagement with the rear wall 28 of the passenger compartment 20 are conventional mechanical features and functions, further description is omitted for the sake of brevity.

As shown in FIGS. 7-10, the support bracket 50 extends from the first side section 42 toward the second side section 44 but does not extend all the way to the second side section 44. In the depicted first embodiment, the support bracket 50 extends from the first side section 42 of the frame structure 36 to just beyond support posts of the headrest 32. Put another way, the support bracket 50 extends from the first side member 42 of the support structure toward and to a central area of the upper section 46 (also referred to as the top section 46) with the headrest 32 being fixed to the frame structure 36 within the central area of the upper section 46.

Further, the support bracket 50 is fixedly attached to the first side section 42 and the upper section 46 (the top section 46) of the frame structure 36 via welding techniques.

As shown in FIGS. 7-10, the tether bracket 34 is attached to the support bracket 50 via mechanical fasteners F₁ and F₂. The tether bracket 34 includes a main portion 66 and the tether flange 68. Preferably, the fastener F₁ is a threaded bolt that is inserted into an opening in the main portion 66 of the tether bracket 34 and threadedly engages a threaded opening (not shown) in the support bracket 50 or nut (not shown) with internal threads. Once the fastener F₁ is tightened, the tether bracket 34 is fixedly attached to the support bracket 50. The fastener F₂ is preferably an alignment pin that fits into an alignment opening in the support bracket 50 preventing the tether bracket 34 from pivoting about the fastener F₁.

As shown in FIGS. 7-10, the main portion 66 of the tether bracket 34 is attached to the second portion 54 of the support bracket 50. Further, the tether flange 68 of the tether bracket 34 is located rearward of the adjacent headrest 32 and is aligned with the headrest 32 and centered relative to the frame structure 36. As well, each of the tether flanges 68 is located rearward of a front portion of the frame structure 36, as shown in FIG. 6. Each of the tether flanges 68 is further located adjacent to and above a top surface 38a of the outer cushion portion 38 of the seat assembly 12, as shown in FIGS. 2, 5 and 6.

Once installed to the support bracket 50, the main portion 66 of the tether bracket 34 is in an upright orientation. The tether flange 68 extends from an upper end of the main portion 66 in a direction that is perpendicular to the main portion 66. Consequently, the tether flange 68 extends in an approximately horizontal direction. Each of the tether brackets 34 and 34a includes a strap 70 that is described further below. The tether flange 68 includes two openings 72 that are described in greater detail below.

The tether brackets 34 and 34a can all be identical. The description of one of the tether brackets 34 above applies equally to both tether brackets 34 and the tether bracket 34a.

As is shown in FIGS. 3 and 4, the two tether brackets 34 are installed to respective ones of the upright seat portions 24 and 26 such that the tether flanges 68 extend in a forward direction from the main portion 66 toward the support posts of the headrests 32. However, the tether bracket 34a is reversed. Specifically, the tether bracket 34a is installed to a support bracket 50a.

As shown in FIG. 10, the support bracket 50a is fixedly attached to an upper section 46a and a second section 44a of a frame structure 36a by, for example, welding techniques. The frame structure 36a is part of the upright portion 26 of the seat assembly 12. The support bracket 50a is positioned within the central portion 26b of the upright portion 26 such that the tether flange 68 of the tether bracket 34a extends in a rearward direction. The frame structure 36a is similar in structure to the frame structure 36. The frame structure 36a includes the first side section 42 (mirror image of the first side section 42 of the frame structure 36). The upper section 46a of the frame structure 36a is longer than the upper section 46a and extends from the first side section 42 to the second side section 44a. The support bracket 50a is attached to the upper section 46a via, for example, welding techniques. There are two support brackets 50. The first is attached to the frame structure 36 as described above, and similarly, the second is attached to the frame structure 36a in a manner identical to the attachment to the frame structure 36 (mirror image thereof).

The tether bracket 34 (and tether bracket 34a) are configured for the purpose of attaching a strap 76 of a child's seat 78 to one of the openings 72 in the tether flange 68. As shown in phantom lines in FIG. 4, a child's seat 78 can be installed to the seat assembly 12. A bottom rearward end of the child's seat 78 includes connectors (not shown) that clip onto or attach to brackets (not shown) in the seat portions 30a and 30b of the seat assembly 12. An upper end of the child's seat 78 includes the strap 76. Preferably, the strap 76 has a minimum length (several feet long) such that the strap 76 can be tightened and loosened easily by a vehicle operator or vehicle passenger.

The strap 76 is positioned to extend around the tether bracket 34 and then to the tether bracket 34a. A hook at the end of the strap 76 extends through one of the openings 72 in the tether flange 68. Thereafter, the strap 76 is tightened such that the child's seat is secured to the seat assembly 12 and the minimum length of the strap 76 is maintained.

The child's seat 78 can be installed in any location along the seat assembly 12 where the seat assembly 12 includes brackets (not shown) in the seat portions 30a and 30b for attachment of the lower portion of the child's seat 78 thereto. The strap 76 can be installed to any one of the tether brackets 34 and 34a that can accommodate the minimum length of the strap 76. When installing the strap 76 to one of the tether brackets 34 and 34a, the strap 76 is preferably fed through the strap 70 or straps 70 of an appropriate one (or appropriate ones) of the tether brackets 34 and 34a.

### Second Embodiment

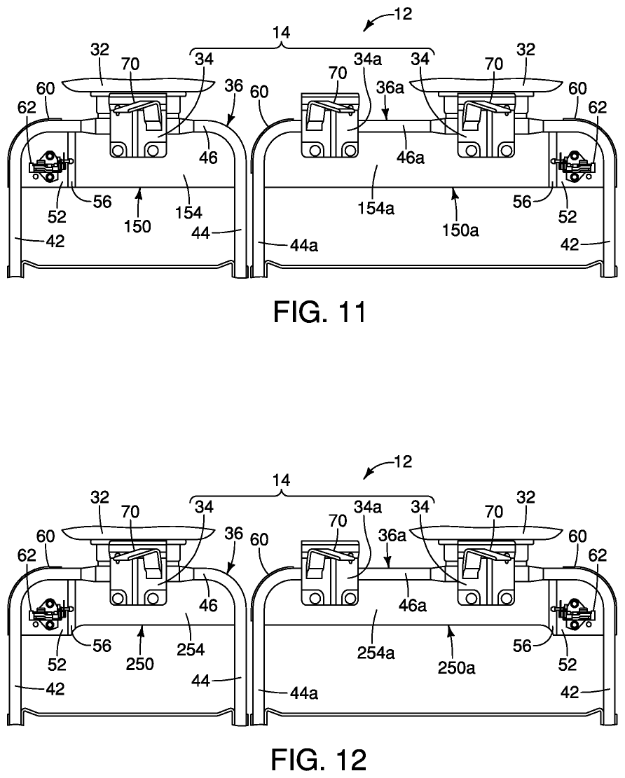

Referring now to FIG. 11, frame structures 36 and 36a having support brackets 150 and 150a, respectively, fixed thereto in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, the support bracket 150 replaces the support bracket 50 of the first embodiment and the support bracket 150a replaces the support bracket 50a. The support bracket 150 includes the first portion 52, the latch mechanism 62, the upper curved section 60 and the offset portion 56, as described above with reference to the first embodiment. However, in the second embodiment, the second portion 54 has been replaced (or modified) with a second portion 154. The second portion 154 extends from the offset portion 56 to the second side portion 44 of the frame structure 36. The second portion 154 is welded or otherwise fixedly attached to the second side portion 44 of the frame structure 36. Similarly, the support bracket 150a includes a second portion 154a that is attached to the second side portion 44a and the upper section 46 of the frame structure 36a.

The tether brackets 34 of the tether structure 14 are attached to the support brackets 150 and 150a in a manner similar to the attachments of the tether brackets 34 as described above with reference to the first embodiment. The tether bracket 34a is attached to a central portion of the second portion 154 of the support bracket 150a.

### Third Embodiment

Referring now to FIG. 12, support brackets 250 and 250a in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the third embodiment, the support bracket 250 replaces the support bracket 50 of the first embodiment and the support bracket 250a replaces the support bracket 50a. The support bracket 250 includes the first portion 52, the latch mechanism 62, the upper curved section 60 and the offset portion 56, as described above with reference to the first embodiment. However, in the third embodiment, the second portion 54 has been replaced (or modified) with a second portion 254. The second portion 254 extends from the offset portion 56 to the second side portion 44 of the frame structure 36. The second portion 254 is welded or otherwise fixedly attached to the second side portion 44 of the frame structure 36. Similarly, the support bracket 250a includes a second portion 254a that is attached to the second side portion 44a and the upper section 46 of the frame structure 36a.

In the third embodiment, the first portion 52 of each of the support brackets 250 and 250a have a first overall height and the second portions 254 and 254 each have an overall height that is less than the first overall height of the first portion 52.

The tether brackets 34 of the tether structure 14 are attached to the support brackets 250 and 250a in a manner similar to the attachments of the tether brackets 34 as described above with reference to the first embodiment. The tether bracket 34a is attached to a central portion of the second portion 254 of the support bracket 250a.

### Fourth Embodiment

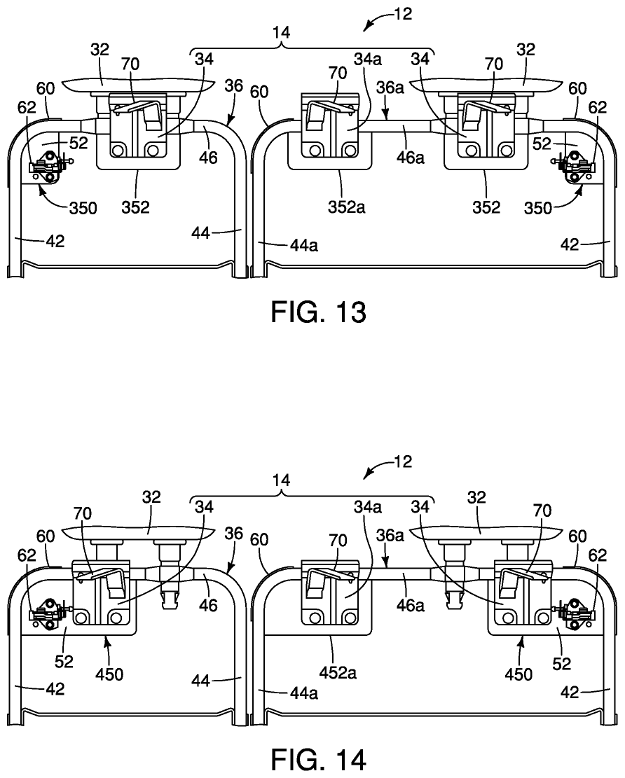

Referring now to FIG. 13, support brackets 350, 352 and 352a in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity.

In the fourth embodiment, the support brackets 350, 352 and 352a replace the support brackets 50 of the first embodiment. There are two support brackets 350 that are welded to respective outboard ends of the frame structures 36 and 36a. The latch mechanisms 62 are installed to respective ones of the support brackets 350. The support brackets 352 are welded to respective of the upper section 46 and 46a of the frame structures 36 and 36a and are aligned with the adjacent one of the headrests 32. The support bracket 352a is welded to the second side section 44a and upper section 46a of the frame structure 36. The support bracket 352a is centered relative to the seat assembly 12.

The tether brackets 34 and 34a are attached to respective ones of the support brackets 352, as shown in FIG. 13 with the tether brackets 34 being aligned with relative to the adjacent headrest 32. In other words, each of the tether brackets 34 is centered behind the adjacent headrest 32.

### Fifth Embodiment

Referring now to FIG. 14, tether brackets 34 and 34a in accordance with a fifth embodiment will now be explained. In view of the similarity between the first and fifth embodiments, the parts of the fifth embodiment that are identical to the parts of the first embodiment will be given the same reference numerals as the parts of the first embodiment. Moreover, the descriptions of the parts of the fifth embodiment that are identical to the parts of the first embodiment may be omitted for the sake of brevity.

In the fifth embodiment, the tether brackets 34 are attached to the brackets 450 at opposite ends of the seat assembly 12. However, the tether brackets 34 are not aligned with the adjacent one of the headrests 32. Specifically, the tether brackets 34 are moved laterally in an outboard direction relative to the adjacent one the headrests 32, as compared to the locations of the tether brackets 34 in FIG. 10 of the first embodiment. Further the tether bracket 34a can further be moved laterally such that it is no longer centered relative to the seat assembly 12. Moving the tether brackets 34 and 34a as shown in FIG. 14 provides for distance for attachment of the strap 76 (not shown in FIG. 14) to extend to the tether flanges 68 of the tether brackets 34 and 34a. The strap 76 of the child's seat 78 (not shown in FIG. 14) must have a minimum length in order to provide plenty of length or slack of tightening and loosening the strap 76.

### Sixth Embodiment

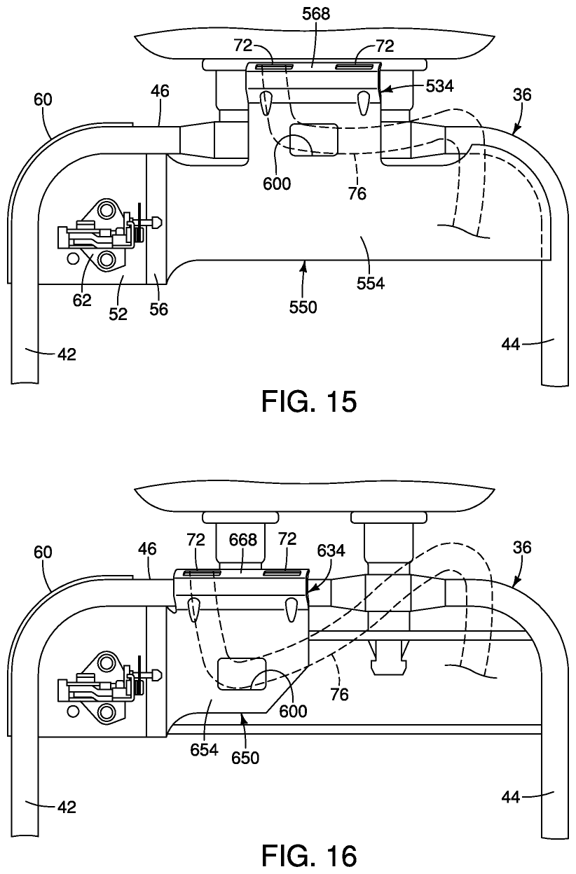

Referring now to FIG. 15, a support bracket 550 in accordance with a sixth embodiment will now be explained. In view of the similarity between the first and sixth embodiments, the parts of the sixth embodiment that are identical to the parts of the first embodiment will be given the same reference numerals as the parts of the first embodiment. Moreover, the descriptions of the parts of the sixth embodiment that are identical to the parts of the first embodiment may be omitted for the sake of brevity.

In the sixth embodiment, the support brackets 50 and the tether brackets 34 are replaced with the support bracket 550. The support bracket 550 includes a tether flange 534. Specifically, the support bracket 550 and the tether flange 534 are manufactured as a single unitary, monolithic element that is preferably made of metal.

The support bracket 550 includes the first portion 52 and the upper curved portion 60, the offset portion 56 and the second portion 54. The upper curved portion 60 is welded to the forward side of the upper section 46 and first side section 42 of the frame structure 36. The second portion 54 is welded to a rearward side of the second side portion 44 and the upper section 46 of the frame structure 36.

The tether flange 534 is positioned such that it is aligned with the headrest. The tether flange 534 includes the two openings 72. The second portion 554 of the support bracket 550 includes an opening 600 below the tether flange 534. As shown in phantom lines (dashed lines) the strap 76 of a child's seat (not shown) can be fed through the opening 600 and then hooked to one of the openings 72 in order to anchor the child's seat. The inclusion of the opening 600 assures that the strap 76 has its required minimum length.

### Seventh Embodiment

Referring now to FIG. 16, a support bracket 650 in accordance with a seventh embodiment will now be explained. In view of the similarity between the first and seventh embodiments, the parts of the seventh embodiment that are identical to the parts of the first embodiment will be given the same reference numerals as the parts of the first embodiment. Moreover, the descriptions of the parts of the seventh embodiment that are identical to the parts of the first embodiment may be omitted for the sake of brevity.

In the seventh embodiment, the support brackets 50 and the tether bracket 34 are replaced with the support bracket 650. The support bracket 650 includes a tether flange 634. Specifically, the support bracket 650 and the tether flange 634 are manufactured as a single unitary, monolithic element that is preferably made of metal.

The support bracket 650 includes the upper curved portion 60 is welded to the forward side of the upper section 46 and first side section 42 of the frame structure 36. A second portion 654 is welded to a rearward side of the upper section 46 of the frame structure 36 and extends from the first side section 42 of the frame structure 36 to a location that is approximately centered between the two posts that support the headrest.

The tether flange 634 is positioned such that it is not aligned with the headrest. Rather, the tether flange 634 is positioned closer to the first side section 42 of the frame structure 36, as compared to the location of the tether flange 534 of the sixth embodiment. More specifically, the tether flange 634 is positioned such that the two openings 72 are located on opposite sides of the outboard one of the posts that support the headrest.

The second portion 654 of the support bracket 650 includes the opening 600 below the tether flange 634. As shown in phantom lines (dashed lines) the strap 76 of a child's seat (not shown) can be fed through the opening 600 and then hooked to one of the openings 72 in order to anchor the child's seat. The inclusion of the opening 600 assures that the strap 76 has its required minimum length.

The vehicle 10 includes many features and elements that are conventional components well known in the art. Since such features and elements are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the tether structure. Accordingly, these terms, as utilized to describe the present invention should be interpreted relative to a vehicle equipped with the tether structure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A tether structure, comprising
a seat assembly having a frame structure and an outer cushion portion;
a support bracket installed to an upper end of the frame structure of the seat assembly, the support bracket including a tether flange located rearward of the frame structure adjacent to a top surface of the outer cushion portion of the seat assembly.

2. The tether structure according to claim 1, wherein
the tether flange is attached to the support bracket proximate the upper end of the frame structure.

3. The tether structure according to claim 2, wherein
the frame structure includes a first side section and a second side section with the support bracket extending from the first side section toward the second side section.

4. The tether structure according to claim 3, wherein
a first portion of the support bracket is fixed to a front side of first side section of the frame structure and a second portion of the support bracket extends along a rearward side of the upper end of the frame structure.

5. The tether structure according to claim 4, wherein
the frame structure further includes a top section that at least partially defines the upper end of the frame structure, the top section extending from the first side section to the second side section with the support bracket extending from the first side member toward to a central area of the top section between the first side section and the second side section, the support bracket being fixedly attached to the top section.

6. The tether structure according to claim 4, wherein
the frame structure includes a top section that at least partially defines the upper end of the frame structure, the top section extending from the first side section to the second side section with the support bracket extending from the first side member to the second side section and being fixedly attached to the top section and the second side section.

7. The tether structure according to claim 1, wherein
the tether flange is part of a tether bracket that includes a main portion and the tether flange, the main portion of the tether bracket being upright and fixedly attached to the support bracket with the tether flange extending horizontally therefrom.

8. The tether structure according to claim 7, wherein
the support bracket has a first portion fixed to a front side of the frame structure and a second portion is offset from the first portion, the second portion extending along a rearward side of the upper end of the frame structure, the main portion of the tether bracket being attached to the second portion of the bracket.

9. The tether structure according to claim 7, wherein
the frame structure includes a first side section and a second side section with the support bracket extending from the first side section to the second side section.

10. The tether structure according to claim 7, wherein
the frame structure includes a top section extending from the first side section to the second side section with the support bracket extending from the first side member toward to a central location of the top section between the first side section and the second side section and being fixedly attached to the top section.

11. The tether structure according to claim 7, wherein
the frame structure includes a top section extending from the first side section to the second side section with the support bracket extending from the first side member to the second side section and being fixedly attached to the top section and the second side section.

12. The tether structure according to claim 7, wherein
the seat assembly includes a head rest centrally located above the seat cushion portion, the tether flange being located rearward of the head rest and is aligned with the head rest.

13. The tether structure according to claim 7, wherein
the seat assembly includes a head rest centrally located above the seat cushion portion, the tether flange being located rearward and offset of the head rest.

14. The tether structure according to claim 1, wherein
the tether flange is part of the support bracket with the tether flange extending horizontally therefrom adjacent to the top surface of the outer cushion portion of the seat assembly.

15. The tether structure according to claim 14, wherein
the seat assembly includes a head rest centrally located above the seat cushion portion, the tether flange being located rearward of the head rest and is aligned with the head rest.

16. The tether structure according to claim 14, wherein
the seat assembly includes a head rest centrally located above the seat cushion portion, the tether flange being located rearward and offset of the head rest.
